(19) United States
(12) Patent Application Publication
(10) Pub. No.: US 2014/0007135 A1
(43) Pub. Date: Jan. 2, 2014

(54) MULTI-CORE SYSTEM, SCHEDULING METHOD, AND COMPUTER PRODUCT

(71) Applicant: FUJITSU LIMITED, Kawasaki-shi (JP)

(72) Inventors: Hiromasa YAMAUCHI, Kawasaki (JP); Koichiro Yamashita, Hachioji (JP); Takahisa Suzuki, Kawasaki (JP); Koji Kurihara, Kawasaki (JP)

(73) Assignee: FUJITSU LIMITED, Kawasaki-shi (JP)

(21) Appl. No.: 13/730,111

(22) Filed: Dec. 28, 2012

Related U.S. Application Data
(63) Continuation of application No. PCT/JP2010/061079, filed on Jun. 29, 2012.

(51) Int. Cl. G06F 9/48

(52) U.S. Cl. CPC G06F 9/4881
USPC 718/107

(57) ABSTRACT

A multi-core system enabling cores to simultaneously execute a task includes memory storing task information including for each task, deadline information indicating a deadline for completion of the task and execution period information indicating an execution period of the task, for cache utilization rates of each core, and power information including for each core, source voltage information indicating a source voltage enabling the core to operate and power deriving information deriving power consumption based on the source voltage; and a core configured to: estimate a process period of the task, based on the execution period information and usable-cache size information, and set a task assignment pattern so that within a range where the estimated process period satisfies a real-time restriction by the deadline information, a cache size used by the task and power consumption that is based on the source voltage information and the power deriving information are minimized.

### CROSS REFERENCE TO RELATED APPLICATIONS

This application is a continuation application of International Application PCT/JP2010/061079, filed on Jun. 29, 2010 and designating the U.S., the entire contents of which are incorporated herein by reference.

### FIELD

The embodiments discussed herein are related to a multi-core system, a scheduling method, and a computer product.

### BACKGROUND

Conventionally, in a system that shares the same memory among multiple processors, programs are controlled to reduce access contention with respect to the memory by exchanging information of access frequency among the processors. In another conventional system, power consumption is controlled by executing programs according to an execution mode selected based on power information. In yet another conventional system that executes multi-task processing, power consumption by the system is reduced by preferentially executing a task that consumes a large amount of the total power used for hardware resources. A method is known, by which the hit rate of cache memory is estimated based on the process period that results when a program is executed after the operation mode of the cache memory is changed. Another method is known where a program is modified based on the size of the cache memory, etc., which affects processor performance, to distribute a proper version of the program.

For examples of the technologies above, refer to Japanese Laid-Open Patent Publication Nos. 2000-148712, 2007-280380, H8-6803, H6-161889, and 2006-92541.

When multi-task processing is performed in a multi-core system, it is desirable to realize lower power consumption while maintaining throughput during multi-task operation. When a conventional power consumption management method is employed, it is difficult to perform optimal power management while maintaining throughput. For example, during multi-task processing by the multi-task system, when a task is switched for another task at a given core, the contents of the cache used by the task may be rewritten. In such a case, rewriting the cache contents results in increased access of the main memory, leading to a decrease in throughput and an increase in power consumption. In a case of looped parallel processing, where data sharing by frequent communication between cores is expected, in particular, the rewriting the contents of a cache used for a task at a given core may reduce throughput significantly.

From the viewpoint of throughput, in comparing serial processing and parallel processing of a task that can be processed in parallel to determine which processing is preferable, the determination is affected by a condition of whether another task uses a cache. Power management is performed in a case where power gating is applied to an idle core to execute serial processing and in a case where dynamic voltage and frequency scaling (DVFS) is employed to execute parallel processing by multiple cores. From the viewpoint of power consumption, in the determination of which case is preferable among the two cases above, consideration is given to the extent that throughput drops consequent to the cache utilization rate and the state of a leak current flow at each core.

In this manner, task scheduling is preferably performed by considering the state of utilization of a cache by each task in an executable state and power characteristics, such as leak current at each core. The conventional methods, however, do not take the state of cache utilization into consideration and thus, have difficulty in maintaining throughput and achieving power-saving simultaneously.

### SUMMARY

According to an aspect of an embodiment, a multi-core system enabling multiple cores to simultaneously execute a task includes a memory storing task information including for each task, deadline information indicating a deadline for completion of the task and execution period information indicating an execution period of the task, corresponding to cache utilization rates for each core, and power information including for each core, source voltage information indicating a source voltage with which the core can operate and power deriving information for deriving power consumption based on the source voltage; and a core configured to estimate a process period of the task, based on the execution period information and usable-cache size information, and set a task assignment pattern so that within a range where the estimated process period of the task satisfies a real-time restriction indicated by the deadline information, a cache size used by the task is minimized and power consumption that is based on the source voltage information and the power deriving information is minimized.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a multi-core system according to a first embodiment;

FIG. 2 is a flowchart of a scheduling method according to the first embodiment;

FIG. 3 is a block diagram of the multi-core system according to a second embodiment;

FIG. 4 depicts an example of a task table;

FIG. 5 depicts an example of a power table;

FIG. 6 depicts an example of a cache size table; and

FIGS. 7, 8, 9, 10, 11, and 12 are flowcharts of a scheduling method according to the second embodiment.

### DESCRIPTION OF EMBODIMENTS

Embodiments of a multi-core system, a scheduling method, and a scheduling program will be described in detail with reference to the accompanying drawings. In the following embodiments, the process period of a task is estimated with consideration of the rate of cache utilization, and a task assignment pattern is set so that the cache size used by the task and power consumption are minimized and within a range in which a real-time restriction is satisfied. The embodiments do not limit the present invention.

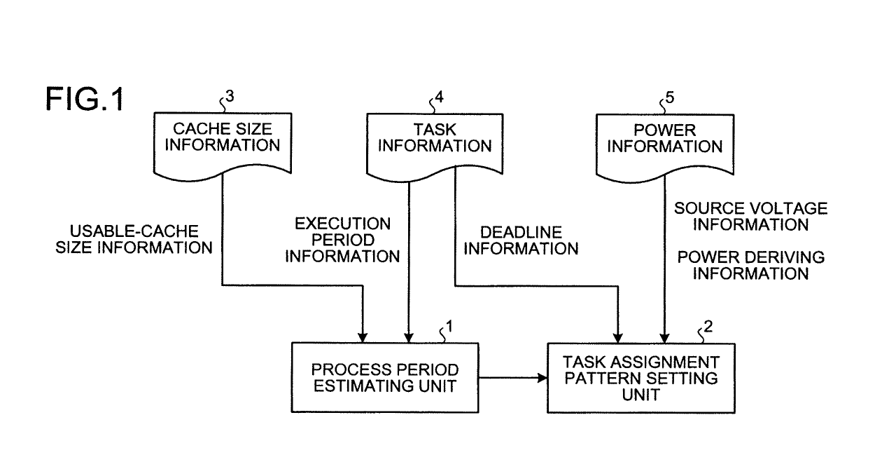

FIG. 1 is a block diagram of a multi-core system according to a first embodiment. As depicted in FIG. 1, the multi-core system includes a process period estimating unit 1, a task assignment pattern setting unit 2, task information 4, and power information 5. The multi-core system also includes cache size information 3, caches (not depicted), and multiple cores (not depicted).

The task information 4 includes for each task, deadline information indicating a deadline for completion of the task. The task information 4 also includes for each task, execution period information indicating for cache utilization rates of each core, the execution period of the task.

The power information 5 includes for each core, source voltage information indicating a source voltage by which the core can operate. The power information 5 also includes for each core, power deriving information for deriving power consumption based on source voltage.

The process period estimating unit 1 acquires execution period information from the task information 4. The process period estimating unit 1 acquires usable-cache size information from the cache size information 3. The process period estimating unit 1 estimates the process period of a task, based on execution period information and usable-cache size information.

The task assignment pattern setting unit 2 acquires deadline information from the task information 4. The task assignment pattern setting unit 2 acquires source voltage information and power deriving information from the power information 5. The task assignment pattern setting unit 2 determines power consumption, based on source voltage information and power deriving information. The task assignment pattern setting unit 2 sets a task assignment pattern so that within a range where the process period estimated by the process period estimating unit 1 satisfies a real-time restriction indicated by deadline information, the cache size used by a task is minimized and power consumption is minimized.

The process period estimating unit 1 and the task assignment pattern setting unit 2 may be implemented by, for example, causing a master core to execute a scheduling program. The scheduling program may be a program that causes a computer to execute a scheduling method, which will be explained next. The scheduling program may be stored in a cache or memory accessed by a core. The cache size information 3, task information 4, and power information 5 may be stored in a cache or memory accessed by a core. The scheduling program may be included in an operating system executed at the master core.

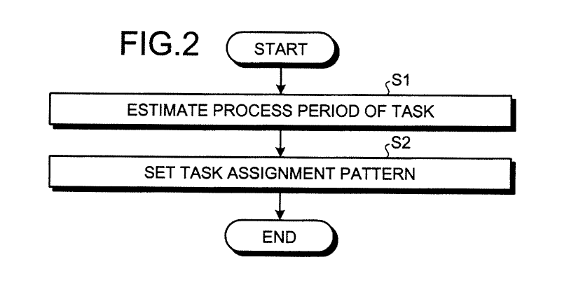

FIG. 2 is a flowchart of the scheduling method according to the first embodiment. As depicted in FIG. 2, when a scheduling process is started, the process period estimating unit 1 estimates the process period of a task (step S1). Here, the process period estimating unit 1 makes the estimation based on execution period information acquired from the task information 4 and on usable-cache size information acquired from the cache size information 3.

Subsequently, the task assignment pattern setting unit 2 sets a task assignment pattern (step S2). Here, the task assignment pattern setting unit 2 sets the task assignment pattern in a range in which the process period of the task estimated at step S1 satisfies a real-time restriction indicated by deadline information acquired from the task information 4. The task assignment pattern setting unit 2 determines power consumption, based on source voltage information and power deriving information acquired from the power information 5. The task assignment pattern setting unit 2 sets the task assignment pattern so that the cache size used by the task and power consumption are minimized.

According to the first embodiment, a task assignment pattern is set so that the cache size used by each task is minimized. As a result, a cache is assigned to tasks greater in number. Rewriting of cache contents in an event of task switching, therefore, becomes less frequent, which reduces the frequency of main memory access and thereby, enables maintenance of throughput. Reducing the frequency of main memory access or setting the task assignment pattern so that power consumption becomes minimized leads to power-saving.

A second embodiment relates to an example of applying the multi-core system to an apparatus having a built-in system, e.g., a portable terminal, such as cellular phone. A portable terminal, such as cellular phone, is supplied with source voltage from, for example, a battery.

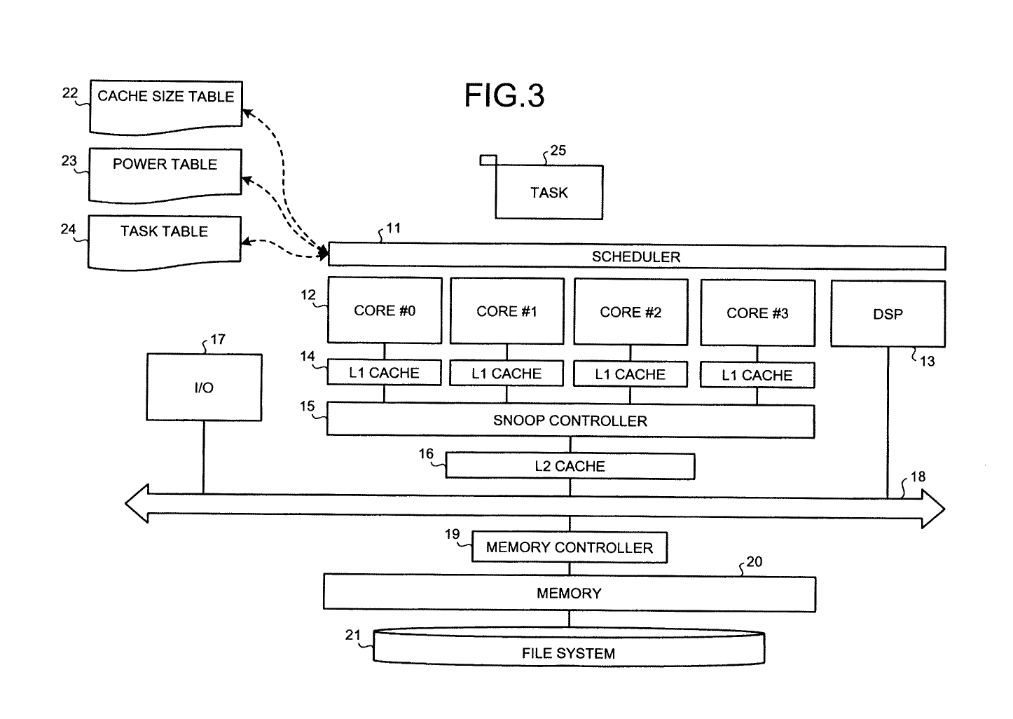

FIG. 3 is a block diagram of the multi-core system according to a second embodiment. As depicted in FIG. 3, the multi-core system includes a scheduler 11 serving as the process period estimating unit and the task assignment pattern setting unit; multiple cores, e.g., four cores (#0 to #3) 12; primary caches (L1 caches) 14 of respective cores; a secondary cache (L2 cache) 16; and memory 20.

The scheduler 11 is implemented by, for example, an operating system executed at the core #0 serving as a master core. The scheduler 11 assigns a task 25 to each of the cores (#0 to #3) 12 according to a scheduling method, which will be described later. At the master core and other cores (#0 to #3), task scheduling for each core is performed by the scheduler implemented by an operating system executed at each core. The operating system is read out of a file system 21 and is assigned to the memory 20.

A snoop controller 15 maintains coherency between data in the memory 20 and in the primary cache 14 and the secondary cache 16. A bus 18 is connected to a memory controller 19 that controls data input/output to/from the memory 20. The bus 18 is also connected to the secondary cache 16, to a digital signal processor (DSP) 13 that processes digital signals, such as audio and video signals, and to an input/output (I/O) interface 17.

The multi-core system also includes a cache size table 22 used as cache size information, a power table 23 used as power information, and a task table 24 used as task information. The cache size table 22, power table 23, and task table 24 may be stored in the memory 20 or, for example, in a cache area of the primary cache 14 or secondary cache 16. The power table 23 and task table 24 are obtained in advance by a simulator, for example, in a stage of designing an application program. The cache size table 22 is made by the scheduler 11 at the start of task assignment, and is updated by the scheduler of each core as processing at each core proceeds.

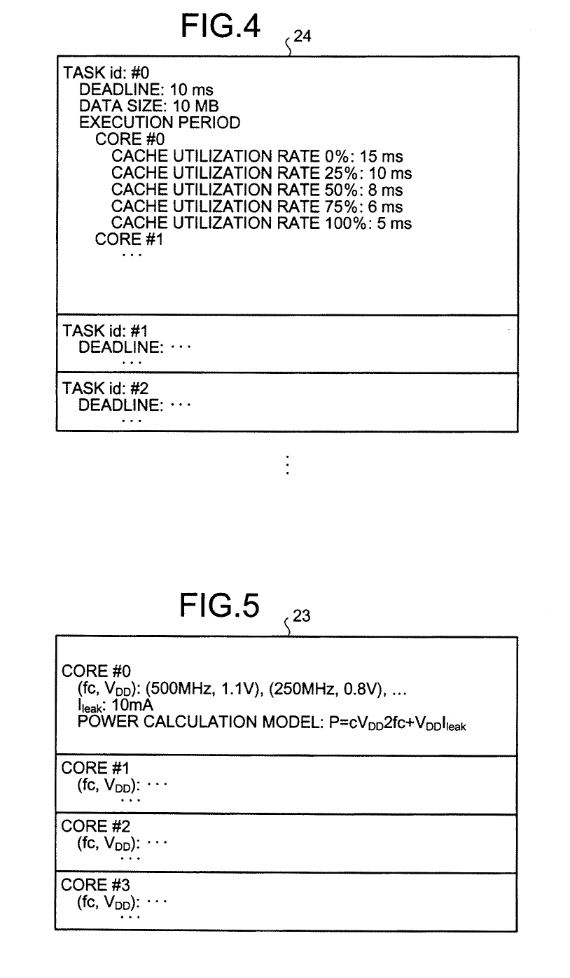

The task table 24 includes information of, for example, a task identifier (id), a deadline, data size, an assignable pattern, and an execution period for each cache utilization rate in an assignable pattern, as task information of each task. Examples of cache utilization rates includes 0%, 25%, 50%, 75%, 100%, etc. Information of a deadline and data size for each task can be obtained by sequentially processing each task in advance, using a simulator, etc. FIG. 4 depicts an example of the task table 24.

The power table 23 includes for each core, information of a clock frequency (f₀), a source voltage (V_{DD}), and a leak current (Iₗₑₐₖ), as processor-related information. The power table 23 also includes for each core, a power calculation model equation (P=. . . ) for calculating power consumption based on a source voltage, a clock frequency, and a leak current. FIG. 5 depicts an example of the power table 23. In the power calculation model equation (P=. . . ) of FIG. 5, “c” in the first term on the right side is a coefficient representing, for example, capacitance.

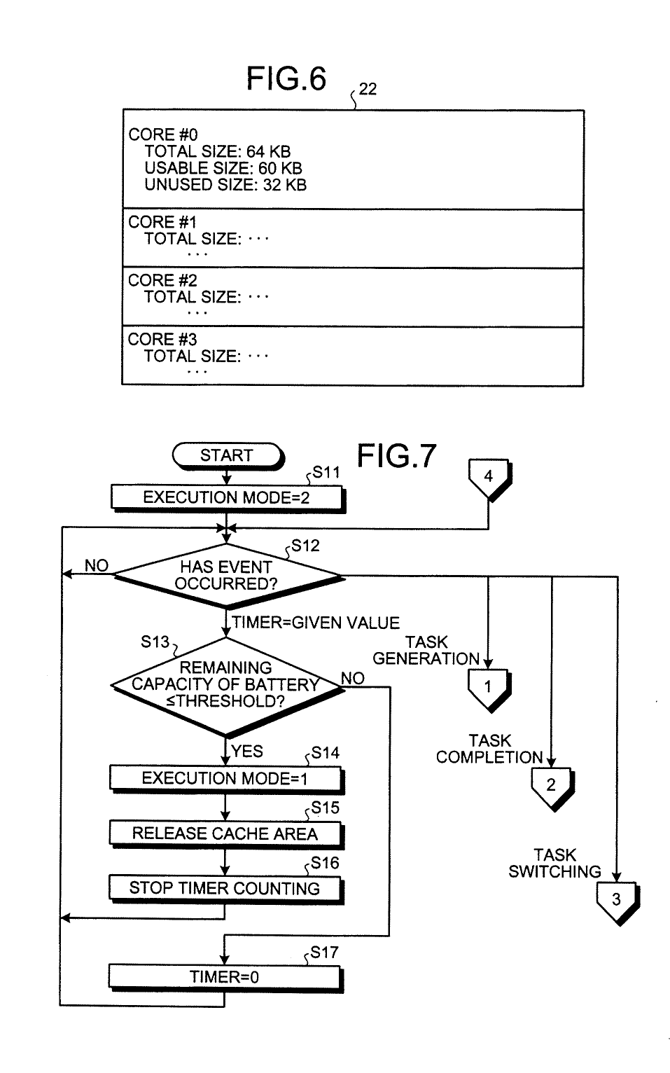

The cache size table 22 includes for each core, information of the total size, usable size, and unused size of a cache. When the operating system is loaded onto the cache, the capacity obtained by subtracting the area of the cache occupied by the operating system from the total size of the cache is the remaining capacity available as the usable size. FIG. 6 depicts an example of the cache size table 22.

FIGS. 7 to 12 are flowcharts of a scheduling method according to the second embodiment. As depicted in FIG. 7, when the scheduling process is started, the scheduler 11 sets the operation mode of the system to an execution mode 2 (step S11). The execution mode 2 is a normal mode, in which the remaining capacity of a battery exceeds a preset threshold.

The scheduler 11 determines whether an event has occurred, and waits for the occurrence of an event (step S12: NO). Events include, for example, the value of a timer incorporated in the system reaching a given value, a task being generated, the completion of a task, and task switching. The timer counts the cycles of checking the remaining capacity of the battery.

When the value of the timer has reached the given value, which is regarded as the occurrence of an event (step S12: timer=given value), the scheduler 11 checks the remaining capacity of the battery and determines if the remaining capacity of the battery is less than or equal to the threshold (step S13). If the remaining capacity of the battery is not less than or equal to the threshold (step S13: NO), the timer is reset to an initial value of 0 (step S17), and the scheduler 11 returns to step S12, where the scheduler 11 monitors for an occurrence of an event.

If the remaining capacity of the battery is less than or equal to the threshold (step S13: YES), the scheduler 11 changes the operation mode of the system to an execution mode 1 (step S14). The execution mode 1 is a low power consumption mode, in which battery power consumption is kept lower than the battery power consumption during the ordinary mode (execution mode 2). When the operation mode is changed to the execution mode 1, a locked cache area is released from the locked state (step S15). Subsequently, the timer stops counting (step S16), and the scheduler returns to step S12 to monitor for an occurrence of an event.

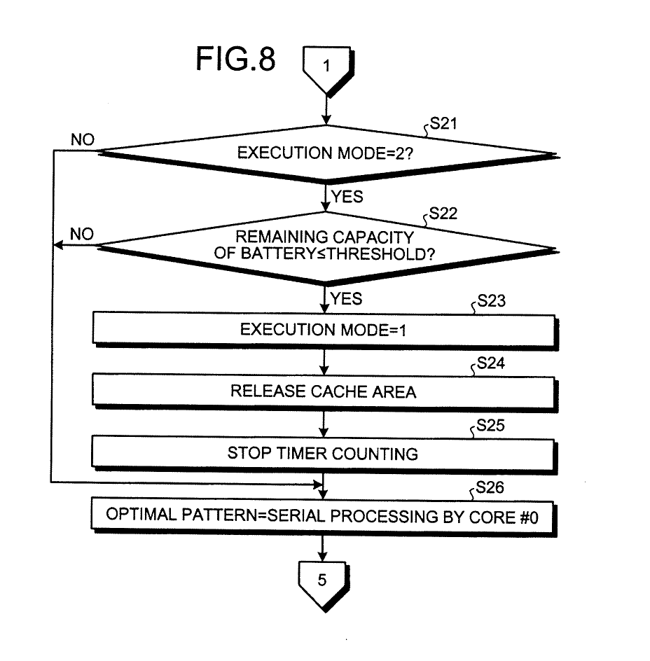

When a task is generated at step S12, which is regarded as the occurrence of an event (step S12: task generation), the scheduler 11 determines whether the operation mode of the system is the execution mode 2, as depicted in FIG. 8 (step S21). If the operation mode of the system is the execution mode 1 (step S21: NO), the scheduler 11 proceeds to step S26. If the operation mode of the system is the execution mode 2 (step S21: YES) and the remaining capacity of the battery is not less than or equal to the threshold (step 22: NO), the scheduler 11 proceeds to step S26. If the operation mode of the system is the execution mode 2 (step S21: YES) and the remaining capacity of the battery is less than or equal to the threshold (step 22: YES), the scheduler 11 changes the operation mode of the system to the execution mode 1 (step S23). As a result, the locked cache area is released from the locked state (step S24), the timer stops counting (step S25), and the flow proceeds to step S26. At step S26, the scheduler 11 sets the optimal assignment pattern for the task to a pattern of serial processing by the core #0.

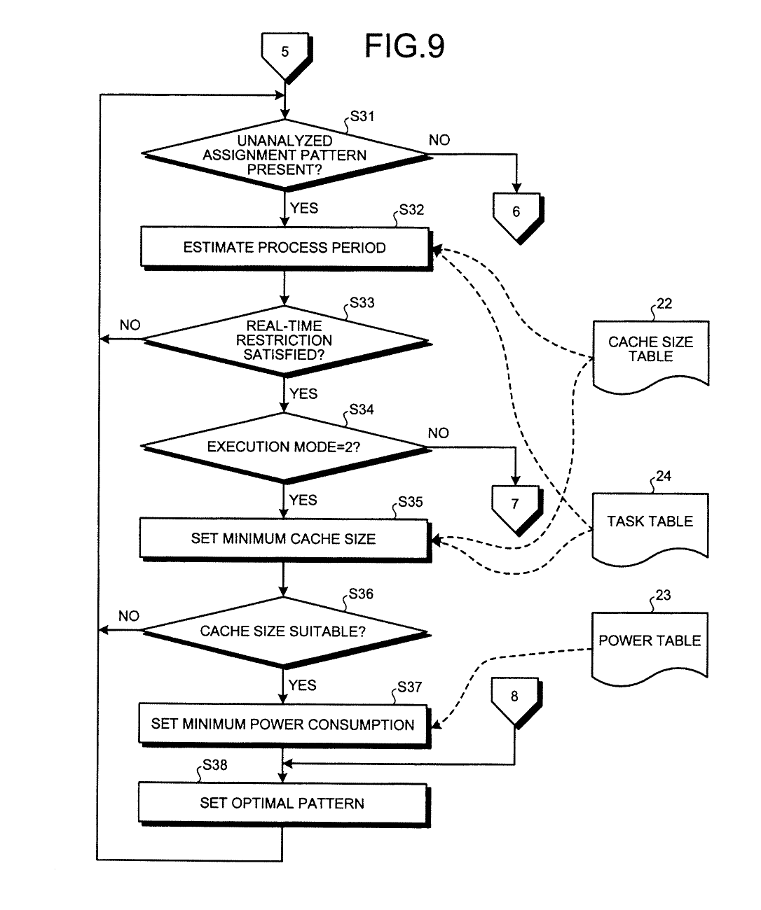

Subsequently, as depicted in FIG. 9, the scheduler 11 determines whether an unanalyzed assignment pattern is present among assignment patterns obtained from the parallel level of the task (step S31). If an unanalyzed assignment pattern is present (step S31: YES), the scheduler 11 refers to the task table 24, and determines an unanalyzed assignment pattern to be the subject of analysis. The scheduler 11 then refers to the cache size table 22, and estimates the process period of the task based on the unused size of the cache of each core (step S32).

The scheduler 11 refers to the task table 24, and determines whether the process period estimated at step S32 is within a range of a real-time restriction (step S33). If the estimated process period is not within a range of the real-time restriction (step S33: NO), the scheduler 11 returns to step S31, determines another unanalyzed assignment pattern to be a new subject of analysis, and executes the same processes subsequent to step S31. If the estimated process period is within a range of the real-time restriction (step S33: YES), the scheduler 11 determines whether the operation mode of the system is the execution mode 2 (step S34).

If the operation mode of the system is the execution mode 2 (step S34: YES), the scheduler 11 refers to the cache size table 22 and the task table 24. The scheduler 11 sets the cache size used in the assignment pattern under analysis to the minimum size within a range in which the cache size meets the real-time restriction (step S35). The scheduler 11 then determines whether the cache size set at step S35 and used in the assignment pattern under analysis is suitable (step S36). The cache size used in the assignment pattern under analysis is suitable if the cache size is smaller than the cache size used in the optimal assignment pattern, and is unsuitable if not smaller the cache size used in the optimal assignment pattern.

If the cache size used in the assignment pattern under analysis is unsuitable (step S36: NO), the scheduler 11 returns to step S31, where the scheduler 11 determines another unanalyzed assignment pattern to be a new subject of analysis, and executes the same processes subsequent to step S31. If the cache size used in the assignment pattern under analysis is suitable (step S36: YES), the scheduler 11 refers to the power table 23. The scheduler 11 estimates power consumption for an assumed case where multiple power control modes, such as power gating and DVFS, are applied to the assignment pattern under analysis, and sets the system mode to a power control mode in which power consumption is minimized. The scheduler 11 also sets power consumption by the assignment pattern under analysis to the minimum power consumption for the assumed case (step S37).

For example, a case is assumed where a deadline for a task is 10 ms and an execution period when the utilization rate of a cache is 100% is 5 ms. It is assumed in this case that sets of the clock frequency (f_{c}) and the source voltage (V_{DD}) [f_{c}, V_{DD}] for a core that executes the task are [500 MHz, 1.1 V] and [250 MHz, 0.8 V] and a leak current (Iₗₑₐₖ) for the same is 10 mA, and that the coefficient c of the power calculation model equation of FIG. 5 is 10⁻¹⁰.

When power gating is applied under these conditions, power consumption W is calculated at 357.5 μj by equation (1). When DVFS is applied, power consumption W is calculated at 240 μj by equation (2). In this case, therefore, DVFS is applied as the power control mode at step S37.

$$\begin{matrix}W = ( {10}^{- 10} \times {1.1}^{2} \times 500 \times {10}^{6} + 1.1 \times 10 \times {10}^{- 3} ) \times 5 \times {10}^{- 3} = 357.5 [ µ J ] & ( 1 ) \\ W = ( {10}^{- 10} \times {0.8}^{2} \times 250 \times {10}^{6} + 0.8 \times 10 \times {10}^{- 3} ) \times 10 \times {10}^{- 3} = 240 [ µ J ] & ( 2 )\end{matrix}$$

Subsequently, the scheduler 11 updates the optimal assignment pattern, and sets the current assignment pattern under analysis to the latest optimal assignment pattern (step S38). The scheduler 11 returns to step S31, and sets another unanalyzed assignment pattern as a new subject of analysis, and executes the same processes subsequent to step S31. In a case of a task whose parallel level is 4, for example, the processes from step S31 to step S38 are executed, for example, on each of the following task assignment patterns: a pattern of task assignment to each core #0, core #1, core #2, and core #3 (serial processing at each core); a pattern of task assignment to each pair of the core #0 and core #1, of the core #0 and core #2, . . . , of the core #3 and #core 4 (parallel processing at two cores); a pattern of task assignment to each group of the core #0, core #1, and core #2, of the core #0, core #1, and core #3, and of the core #0, core #2, and core #3 (parallel processing at three cores); and a pattern of task assignment to a group of #0, core #1, core #2, and core #3 (parallel processing at four cores).

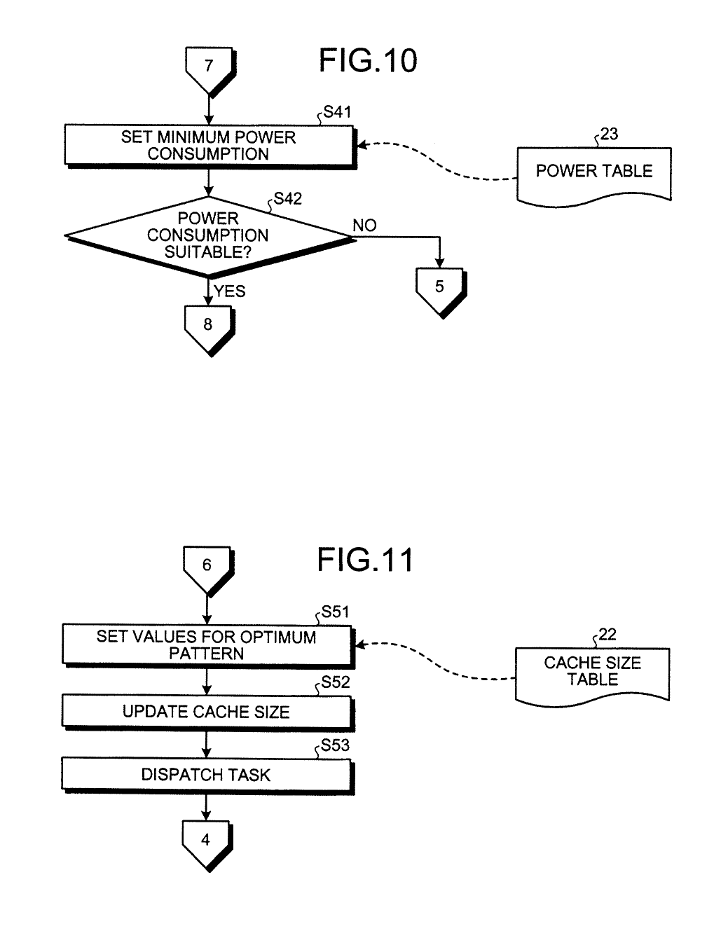

If the process period estimated at step S32 is within the range of the real-time restriction (step S33: YES) and the operation mode of the system is the execution mode 1 (step S34: NO), the scheduler 11 refers to the power table 23, as depicted in FIG. 10. The scheduler 11 estimates power consumption for an assumed case where multiple power control modes, such as power gating and DVFS, are applied to the assignment pattern under analysis, and sets the system mode to the power control mode for which power consumption is minimized. The scheduler 11 also sets power consumption by the assignment pattern under analysis to the minimum power consumption for the assumed case (step S41).

The scheduler 11 then determines whether the power consumption by the assignment pattern under analysis and set at step S41 is suitable (step S42). The power consumption by the assignment pattern under analysis is suitable if the power consumption is smaller than power consumption by the optimum assignment pattern, and is unsuitable if not smaller the power consumption by the optimum assignment pattern.

If the power consumption by the optimum assignment pattern is unsuitable (step S42: NO), the scheduler 11 returns to step S31, where the scheduler 11 determines another unanalyzed assignment pattern to be a new subject of analysis, and executes the same processes subsequent to step S31. If the power consumption by the optimum assignment pattern is suitable (step S42: YES), the scheduler 11 returns to step S38, where the scheduler 11 sets the current unanalyzed assignment pattern to the latest optimum assignment pattern.

If no unanalyzed assignment pattern remains (step S31: NO), the scheduler 11 sets a clock frequency and a source voltage for each core to which a task is to be assigned, to preset values for the optimum assignment pattern at that point of time, as depicted in FIG. 11 (step S51). Subsequently, the scheduler of each core to which the task is to be assigned updates in the cache size table 22, the unused size of the cache of each core (step S52). The scheduler 11 then dispatches the task (step S53), and returns to step S12 to monitor for an occurrence of an event.

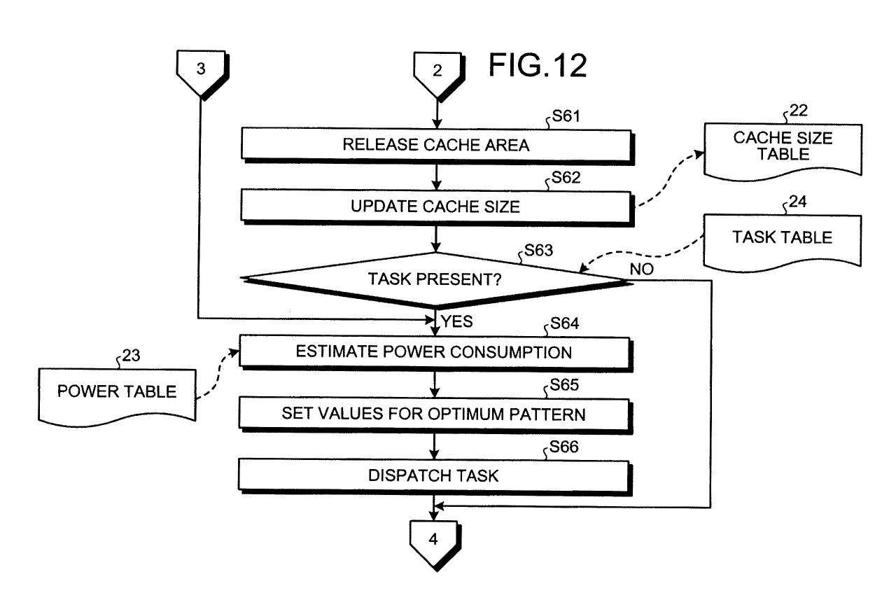

When execution of the task has ended, which is regarded as an event (step S12: task end), a locked cache area is released from the locked state, as depicted in FIG. 12 (step S61). Subsequently, the scheduler 11 of each core updates in the cache table 22, the unused size of the cache of each core (step S62). The scheduler 11 refers to the task table 24 and determines whether an executable task is present (step S63). If an executable task is not present (step S63: NO), the scheduler 11 returns to step S12 to monitor for an occurrence of an event.

If an executable task is present (step S63: YES), the scheduler 11 refers to the power table 23. The scheduler 11 estimates power consumption for an assumed case where multiple power control modes, such as power gating and DVFS, are applied to the task to be executed next, and selects the power control mode in which power consumption is minimized (step S64). Subsequently, the scheduler 11 sets a clock frequency and a source voltage for each core to which the task is to be assigned, to preset values for the optimum assignment pattern at that point of time (step S65). The scheduler 11 dispatches the task (step S66), and returns to step S12 to monitor for an occurrence of an event.

When task switching occurs at step S12, which is regarded as an event (step S12: task switching), processes at step S64 to step S66 are executed, as depicted in FIG. 12. The scheduler 11 then returns to step S12 to monitor for an occurrence of an event.

According to the second embodiment, when the remaining capacity of the battery exceeds the threshold, energy is saved while throughput is maintained in the same manner as in the first embodiment. When the remaining capacity of the battery is less than or equal to the threshold, a task assignment pattern is set so that power consumption is minimized, which enables power-saving.

In the description of the first and second embodiments, a multi-core processor that is a single microprocessor having multiple built-in cores is taken as an example of the multi-core system. A multi-processor having multiple microprocessors may also be applied to the multi-core system. When the multi-processor is applied to the multi-core system, cores in the above description are equivalent to processors. The power calculation model is not limited to the model described in the second embodiment. Power management methods are not limited to power gating and DVFS.

According to the multi-core system, the scheduling method, and the computer product, the maintenance of throughput and power-saving can be achieved simultaneously in the multi-core system.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core system enabling a plurality of cores to simultaneously execute a task, the multi-core system comprising:
a memory storing:
task information including for each task, deadline information indicating a deadline for completion of the task and execution period information indicating an execution period of the task and corresponding to cache utilization rates for each core, and
power information including for each core, source voltage information indicating a source voltage with which the core can operate and power deriving information for deriving power consumption based on the source voltage; and
a core configured to:
estimate a process period of the task, based on the execution period information and usable-cache size information, and
set a task assignment pattern so that within a range where the estimated process period of the task satisfies a real-time restriction indicated by the deadline information, a cache size used by the task is minimized and power consumption that is based on the source voltage information and the power deriving information is minimized.

2. The multi-core system according to claim 1, wherein
the core sets the task assignment pattern so that the used cache size is minimized and the power consumption is minimized when a remaining battery capacity exceeds a threshold, and sets the task assignment pattern so that power consumption is minimized when the remaining battery capacity is less than or equal to the threshold.

3. The multi-core system according to claim 1, wherein
the core estimates a process period for all combinations of cores to which a task can be assigned, and
the core sets the task assignment pattern from among task assignment patterns for the combinations of cores.

4. The multi-core system according to claim 1, wherein
the memory stores cache size information that includes information of a usable-cache size for each core, and
the core updates the cache size information.

5. A scheduling method of scheduling a task in a multi-core system capable of simultaneously executing tasks at a plurality of cores, the scheduling method executed by a computer and comprising:
estimating a process period of a task based on usable-cache size information for the task and execution period information for the task, corresponding to cache utilization rates of each core; and
setting a task assignment pattern so that within a range where the estimated process period of the task satisfies a real-time restriction by deadline information indicating a deadline for completion of the task, a cache size used by the task is minimized and power consumption is minimized that is based on source voltage information indicating a source voltage with which a core can operate and based on power deriving information for deriving power consumption based on the source voltage.

6. The scheduling method according to claim 5, wherein
the setting includes setting the task assignment pattern so that the used cache size is minimized and the power consumption is minimized when a remaining battery capacity exceeds a threshold, and setting the task assignment pattern so that power consumption is minimized when the remaining battery capacity is less than or equal to the threshold.

7. The scheduling method according to claim 5, wherein
the estimating includes estimating a process period for all combinations of cores to which a task can be assigned, and
the setting includes setting the task assignment pattern from among task assignment patterns for the combinations of cores.

8. The scheduling method according to claim 5, further comprising
updating cache size information for each core, after the task assignment pattern is set at the setting.

9. A computer-readable recording medium storing a scheduling program that causes a computer to execute a process comprising:
reading from memory and for a task, usable-cache size information and execution period information corresponding to cache utilization rates of each core;
estimating a process period of the task, based on the cache size information and the execution period information;
reading from the memory, deadline information indicating a deadline for completion of the task, source voltage information indicating a source voltage enabling core operation, and power deriving information for deriving power consumption based on the source voltage; and
setting a task assignment pattern so that within a range where the estimated process period of the task satisfies a real-time restriction indicated by the deadline information, a cache size used by the task is minimized and power consumption that is based on the source voltage information and the power deriving information is minimized.

10. The computer-readable recording medium according to claim 9, wherein
the setting includes setting the task assignment pattern so that the used cache size is minimized and the power consumption is minimized when a remaining battery capacity exceeds a threshold, and setting the task assignment pattern so that power consumption is minimized when the remaining battery capacity is less than or equal to the threshold.

11. The computer-readable recording medium according to claim 9, wherein
the estimating includes estimating a process period for all combinations of cores to which a task can be assigned, and
the setting includes setting the task assignment pattern from among task assignment patterns for the combinations of cores.

12. The computer-readable recording medium according to claim 9, the process further comprising
updating the usable-cache size information stored for each core, in the memory.
